(19) United States
(12) Patent Application Publication
(10) Pub. No.: US 2010/0328473 A1
(43) Pub. Date: Dec. 30, 2010

(54) DIGITAL PHOTOGRAPHING APPARATUS AND METHOD FOR DEALING WITH SHAKE

(76) Inventors: Young-jae Hwang, Suwon-si (KR); Kwang-seok Byon, Suown-si (KR); Jung-soo Kim, Suwon-si (KR); Chi-young Park, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(21) Appl. No.: 12/724,798

(22) Filed: Mar. 16, 2010

(30) Foreign Application Priority Data
Jun. 25, 2009 (KR) 10-2009-0057198

(51) Int. Cl. H04N 5/228

(52) U.S. Cl. 348/208.11; 348/E05.031

(57) ABSTRACT

Provided is a digital photographing apparatus and method of obtaining data of a clear image even though the digital photographing apparatus shakes. The digital photographing apparatus includes: a lens; an imaging device generating data from light incident through the lens; an imaging device base on which the imaging device is disposed; a light diode integrated circuit disposed on the imaging device base; and an imaging device base actuator moving the imaging device base and controlling a position of the imaging device. The method comprises generating data from light incident through a lens; detecting a direction of shake of the digital photographing apparatus according to a difference in the amount of light detected in each of four regions of the surface of a light diode integrated circuit; and changing a position of the imaging device in the opposite direction to the detected direction of the shake.

### CROSS-REFERENCE TO RELATED PATENT APPLICATION

This application claims the benefit of Korean Patent Application No. 10-2009-0057198, filed on Jun. 25, 2009, in the Korean Intellectual Property Office, the disclosure of which is incorporated herein in its entirety by reference.

### BACKGROUND

The present invention relates to a digital photographing apparatus, and more particularly, to a digital photographing apparatus and method capable of obtaining data of a clear image although the digital photographing apparatus shakes while the digital photographing apparatus has a simple structure.

In general, a digital photographing apparatus is an apparatus generating and/or storing data of images. Examples of the digital photographing apparatus include a digital still camera (DSC), a digital video camera (DVC), digital cameras installed in mobile phones, and so forth.

Since a large number of such digital photographing apparatuses are in use today, consumers are increasingly demanding high quality still images and/or moving images, and thus demands are increasing for digital photographing apparatuses that include a hand shake correction apparatus for preventing reduced image clarity caused by the hand of a user shaking. A conventional hand shake correction apparatus performs a hand shake prevention function by moving a hand shake correction lens or an imaging device.

The hand shake correction apparatus of the conventional digital photographing apparatus needs two gyro sensors that detect a direction and the amount of shake of the digital photographing apparatus and two hall sensors that detect the amount of compensation and provide feedback on the detected amount of compensation. However, the conventional digital photographing apparatus needs two gyro sensors to detect an amount of shake thereof in directions x and y and two hall sensors to provide feedback on the detected amount of shake, thus increasing the number of necessary parts, rendering complex the conventional digital photographing apparatus, and increasing the manufacturing costs.

### SUMMARY

The present invention provides a digital photographing apparatus, with a simple structure, and a method for obtaining data of a clear image even though the digital photographing apparatus is shaken by the user during use.

According to an aspect of the present invention, there is provided a digital photographing apparatus including: a lens; an imaging device generating data from light incident through the lens; an imaging device base on which the imaging device is disposed; a light diode integrated circuit disposed on the imaging device base; and an imaging device base actuator moving the imaging device base to control a position of the imaging device.

A part of the light passing through the lens may be incident to the light diode integrated circuit. A surface of the light diode integrated circuit to which light is incident may be divided into a first region through a fourth region.

A direction of shake of the digital photographing apparatus may be detected according to a difference in an amount of the light detected in the first region through the fourth region of the light diode integrated circuit, and the imaging device base actuator may change a position of the imaging device in the opposite direction to the detected direction of the shake of the digital photographing apparatus. In one embodiment, if the amount of light detected in the first and third region is greater than that detected in the second and fourth region, the direction of shake of the digital photographing apparatus is determined to be along the y-axis. In another embodiment, if the amount of light detected in the second and fourth regions is greater than that detected in the first and third regions, the direction of shake of the digital photographing apparatus is determined to be along the x-axis. In yet another embodiment, if the amount of light detected in the second region is greater than that detected in the fourth region, the direction of shake of the digital photographing apparatus is determined to be along the negative x-axis and if the amount of light detected in the fourth region is greater than that detected in the second region, the direction of shake of the digital photographing apparatus is determined to be along the positive x-axis.

A sub-lens may be disposed in a front of the light diode integrated circuit so that the light is incident to the light diode integrated circuit through the sub-lens. An axis of the light incident to the light diode integrated circuit may not be perpendicular to a surface of the light diode integrated circuit to which the light is incident.

According to another aspect of the present invention, there is provided a digital photographing apparatus including: a lens including a shake correction lens; an imaging device generating data from light incident through the lens; a correction lens base on which the shake correction lens is disposed; a light diode integrated circuit disposed on the correction lens base; and a correction lens base actuator moving the correction lens base to control a position of the shake correction lens.

A part of the light passing through the lens may be incident to the light diode integrated circuit. A surface of the light diode integrated circuit to which light is incident may be divided into a first region through a fourth region.

A direction of shake of the digital photographing apparatus may be detected according to a difference in an amount of the light detected in the first region through the fourth region of the light diode integrated circuit, and the correction lens base actuator changes a position of the shake correction lens in the opposite direction to the detected direction of the shake of the digital photographing apparatus. In an embodiment, if the amount of light detected in the second and fourth regions is greater than that detected in the first and third regions, the direction of shake of the digital photographing apparatus is determined to be along the x-axis. In yet another embodiment, if the amount of light detected in the second region is greater than that detected in the fourth region, the direction of shake of the digital photographing apparatus is determined to be along the negative x-axis and if the amount of light detected in the fourth region is greater than that detected in the second region, the direction of shake of the digital photographing apparatus is determined to be along the positive x-axis.

A sub-lens may be disposed in a front of the light diode integrated circuit so that the light is incident to the light diode integrated circuit through the sub-lens. An axis of the light incident to the light diode integrated circuit may not be perpendicular to a surface of the light diode integrated circuit to which the light is incident.

In another embodiment a method is provided for reducing the effect of the shaking on a digital photographing apparatus on an image. The method comprises generating, by an imaging device, data from light incident through a lens; providing an imaging device base on which the imaging device is disposed and a light diode integrated circuit is disposed, the light diode integrated circuit including a surface divided into four regions; detecting a direction of shake of the digital photographing apparatus according to a difference in an amount of light detected in each of the four regions of the surface of the light diode integrated circuit; and changing a position of the imaging device in the opposite direction to the detected direction of the shake of the digital photographing apparatus by moving the imaging device base.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a digital photographing apparatus according to an embodiment of the present invention;

FIG. 2 is a schematic perspective view of a part of the digital photographing apparatus including an imaging device of FIG. 1 according to an embodiment of the present invention;

FIG. 3 is a schematic plan view of a light diode integrated circuit of FIG. 2;

FIGS. 4A through 4C are conceptual diagrams for explaining a principle of detecting shake of the digital photographing apparatus in the light diode integrated circuit according to embodiments of the present invention;

FIGS. 5A and 5B are conceptual diagrams illustrating the detection of the direction of shake of the digital photographing apparatus in the light diode integrated circuit according to embodiments of the present invention; and

FIG. 6 is a schematic perspective view of a part of a digital photographing apparatus including a shake correction lens according to another embodiment of the present invention.

### DETAILED DESCRIPTION OF THE EMBODIMENTS

Hereinafter, the present invention will be described in detail by explaining preferred embodiments of the invention with reference to the attached drawings. Like reference numerals in the drawings denote like elements.

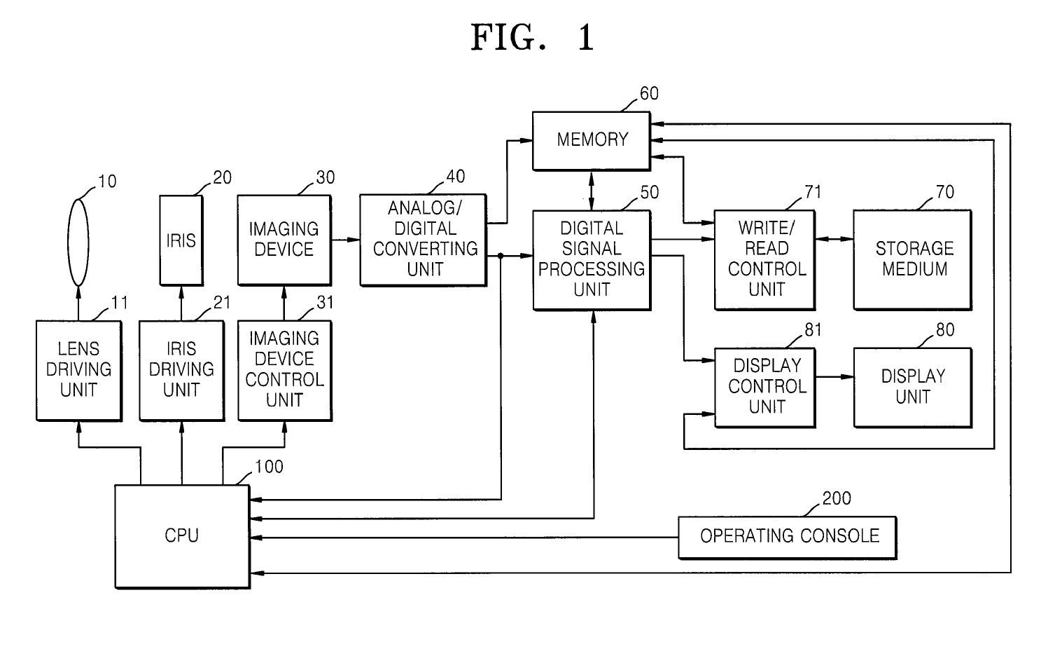

FIG. 1 is a block diagram illustrating a digital photographing apparatus according to an embodiment of the present invention.

Operations of the digital photographing apparatus are controlled by a CPU 100. Furthermore, the digital photographing apparatus includes an operating console 200 including keys for generating electric signals in response to user operation. Electric signals from the operating console 200 are transmitted to the CPU 100, so that the CPU 100 can control the digital photographing apparatus according to the electric signals.

In the case of an image capturing mode, as electric signals from a user are transmitted to the CPU 100, the CPU 100 recognizes the signals and controls a lens driving unit 11, an iris driving unit 21, and an imaging device control unit 31. As a result, a position of a lens 10, an opening of an iris 20, and the sensitivity of an imaging device 30 are controlled. The imaging device 30 generates data from light incident through the lens 10. An analog/digital converting unit 40 converts analog data output by the imaging device 30 to digital data. However, the analog/digital converting unit 40 may not be necessary according to characteristics of the imaging device 30.

Data output by the imaging device 30 may be input to a digital signal processing unit 50 via a memory 60, may be directly input to the digital signal processing unit 50, and, if required, may be input to the CPU 100. Here, the memory 60 may refer to read-only memory (ROM), random-access memory (RAM), etc. The digital signal processing unit 50 may perform digital signal processes, such as gamma correction, white balance adjustment, etc., if required.

Digital data output by the digital signal processing unit 50 is transmitted to a display control unit 81 either directly or via the memory 60. The display control unit 81 controls a display unit 80 to display the digital data. Furthermore, digital data output by the digital signal processing unit 50 is input to a write/read control unit 71 either directly or via the memory 60. The write/read control unit 71 stores the digital data either according to a signal from a user or automatically. The write/read control unit 71 may also read data from files stored in a storage medium 70 and input the data to the display control unit 81 either via the memory 60 or elsewhere such that the digital data is displayed on the display unit 80. The storage medium 70 may be either removable from or permanently installed in a digital photographing apparatus.

The elements of the digital photographing apparatus according to the present embodiment of the present invention are not limited to the embodiment above. The digital photographing apparatus according to another embodiment of the present invention may include the lens 10 and the imaging device 30. The digital photographing apparatus according to another embodiment of the present invention may also include other elements that are not shown in FIG. 1.

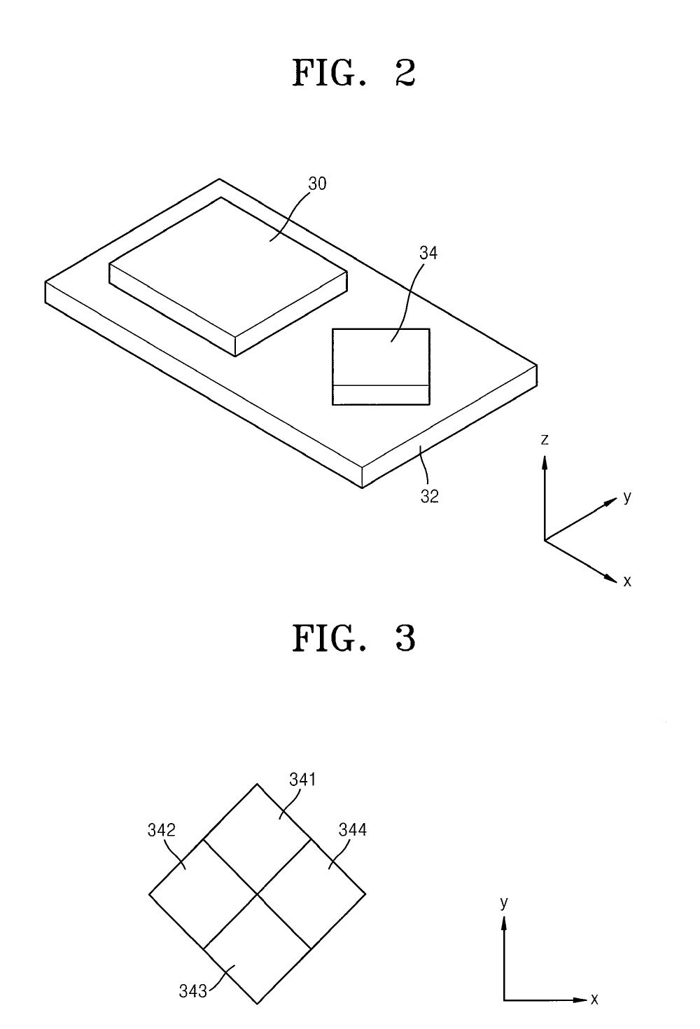

FIG. 2 is a schematic perspective view of a part of the digital photographing apparatus including the imaging device 30 of FIG. 1 according to an embodiment of the present invention. Referring to FIG. 2, the digital photographing apparatus of the present embodiment includes the imaging device 30 that generates data from light incident thereto in a direction of z through the lens 10 and is disposed on an imaging device base 32. A light diode integrated circuit 34 is also disposed on the imaging device base 32. The imaging device base 32 moves by an imaging device base actuator (not shown) and thus a position of the imaging device 30 disposed on the imaging device base 32 is controlled.

In more detail, the light diode integrated circuit 34 that generates data from light incident thereto may detect a direction and amount of shake of the digital photographing apparatus by analyzing the data. The imaging device base actuator moves the imaging device base 32 based on the detected direction and amount of shake, which minimizes the amount of shake of the imaging device 30 even though the digital photographing apparatus shakes, and thus the imaging device 30 can generate data of a clear image. Light incident to the light diode integrated circuit 34 may be a part of the light that passes through the lens 10 or may not pass through the lens 10. The data generated by the light diode integrated circuit 34 may include feedback information determining if the imaging device 30 is disposed in a proper position according to the operation of the imaging device base actuator, in addition to information about the direction and amount of shake of the digital photographing apparatus. Therefore, the light incident to the light diode integrated circuit 34 may be a part of the light that passes through the lens 10 and is incident to the imaging device 30.

FIG. 3 is a schematic plan view of the light diode integrated circuit 34 of FIG. 2. Referring to FIG. 3, a surface of the light diode integrated circuit 34 to which light is incident is divided into a first region 341 through a fourth region 344. Thus, the direction and amount of shake of the digital photographing apparatus can be exactly detected from the data generated from the incident light by the light diode integrated circuit 34.

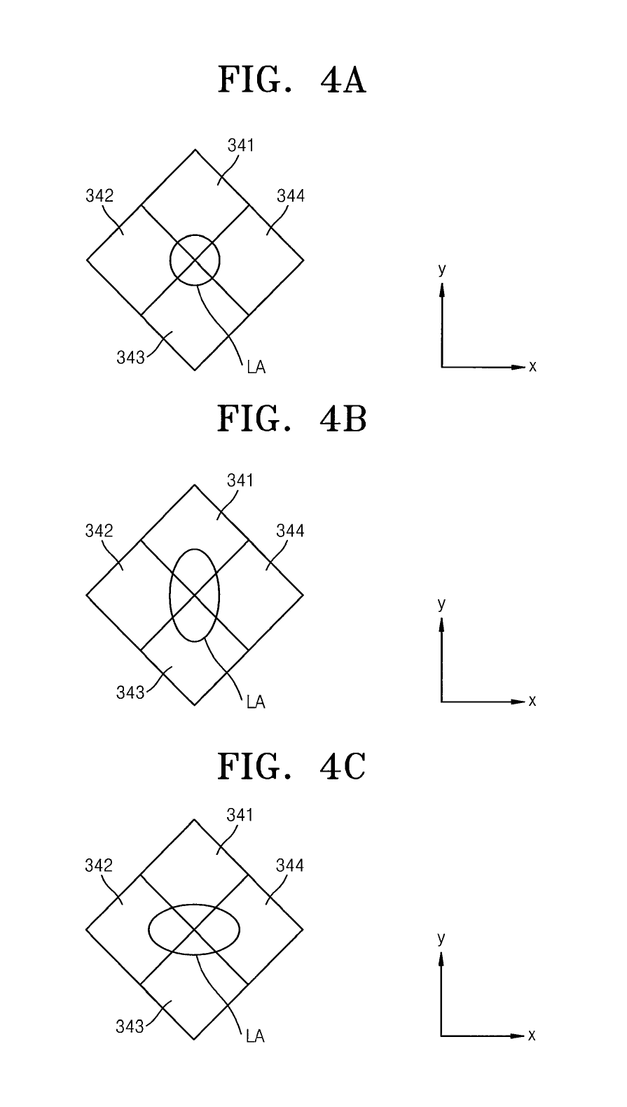

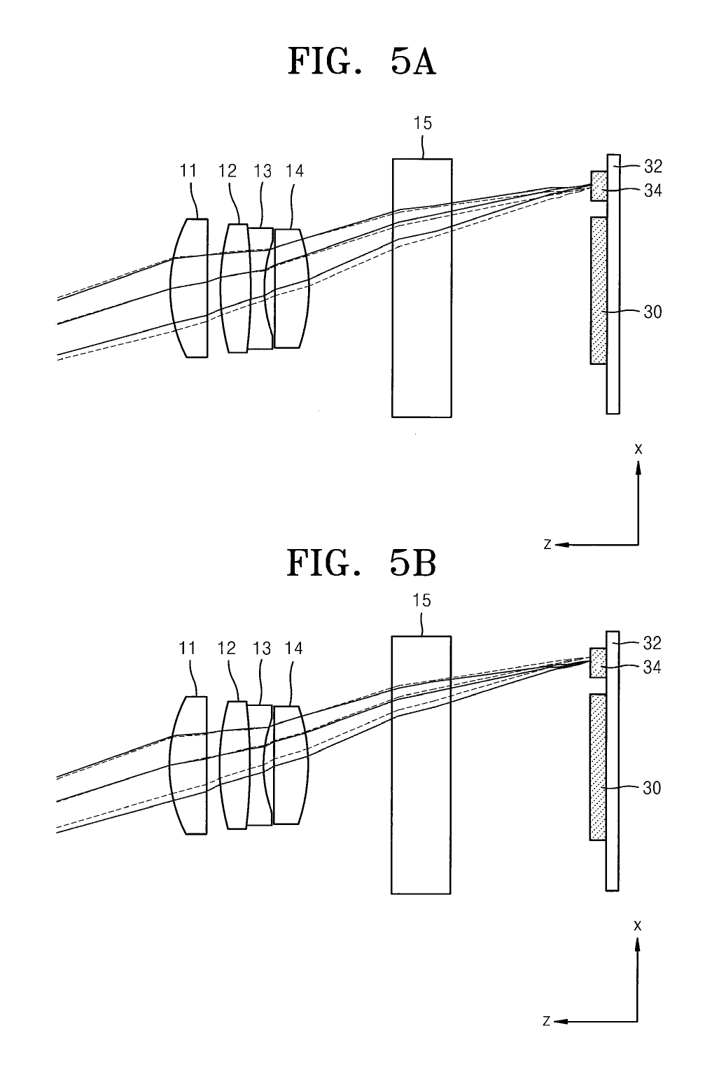

In more detail, the direction of shake of the digital photographing apparatus can be detected according to a difference in the amount of the light incident to each of the first region 341 through the fourth region 344 of the light diode integrated circuit 34. The detection of the direction of shake of the digital photographing apparatus will now be described with reference to FIGS. 4A through 4C.

FIGS. 4A through 4C are conceptual diagrams for explaining a principle of detecting shake of the digital photographing apparatus in the light diode integrated circuit 34 according to embodiments of the present invention.

FIG. 4A is a conceptual diagram of an incident light region LA of the light diode integrated circuit 34 when there is no shake of the digital photographing apparatus. When there is no shake of the digital photographing apparatus, light is incident to a center part of the light diode integrated circuit 34 so that the first region 341 through the fourth region 344 of the light diode integrated circuit 34 have the same area and degree of light irradiated thereto. Therefore, when the first region 341 through the fourth region 344 of the light diode integrated circuit 34 have the same degree of light irradiated thereto, it is determined that the digital photographing apparatus does not shake and thus the imaging device base actuator does not move the imaging device base 32.

FIG. 4B is a conceptual diagram of an incident light region LA of the light diode integrated circuit 34 when the digital photographing apparatus shakes in a direction ±y. When the digital photographing apparatus shakes in the direction ±y, light is not incident to the center part of the light diode integrated circuit 34 as shown in FIG. 4A and is incident to the light diode integrated circuit 34 in the shape of an oval as shown in FIG. 4B. After the shake of the digital photographing apparatus in the direction ±y is completed, the light may be incident to the center part of the light diode integrated circuit 34 as shown in FIG. 4A.

In the incident light region LA of FIG. 4B, an area of the first region 341 and the third region 343 to which light is irradiated is greater than that of the second region 342 and the fourth region 344 to which light is irradiated. Therefore, if the light degree detected in the first region 341 and the third region 343 is higher than that detected in the second region 342 and the fourth region 344, it is determined that the digital photographing apparatus shakes in the direction ±y.

Although the digital photographing apparatus shakes in a different direction from the direction ±y according to a difference in the light degree detected in the first region 341 through the fourth region 344, a corresponding direction of shake of the digital photographing apparatus can be determined. For example, in an incident light region LA shown in FIG. 4C, an area of the second region 342 and the fourth region 344 to which light is irradiated is greater than that of the first region 341 and the third region 343 to which light is irradiated. Therefore, if the light degree detected in the second region 342 and the fourth region 344 is higher than that detected in the first region 341 and the third region 343, it is determined that the digital photographing apparatus shakes in a direction ±x. A direction of shake of the digital photographing apparatus different from the direction ±x can be exactly determined.

If the shake of the digital photographing apparatus is detected from the data generated by the light diode integrated circuit 34, the imaging device base actuator moves the imaging device base 32 in the opposite direction to the detected direction of shake of the digital photographing apparatus and changes a position of the imaging device 30. Thus, although the digital photographing apparatus shakes, an amount of shake in a relative position between the light incident to the imaging device 30 and the imaging device 30 is reduced, so that the imaging device 30 can generate data of a clear image.

FIGS. 5A and 5B are conceptual diagrams for in detail explaining a principle of detecting a direction of shake of the digital photographing apparatus in the light diode integrated circuit 34 according to embodiments of the present invention. When the digital photographing apparatus shakes in the direction ±x, the light diode integrated circuit 34 has the incident light region LA shown in FIG. 4C. Thus, it is necessary for determining whether the digital photographing apparatus shakes in a direction +x or −x.

Referring to FIG. 5A which shows that the digital photographing apparatus shakes in the direction −x, light is incident to the imaging device 30 through lenses 11 through 15, and a part of the light passing through the lenses 11 through 15 is incident to the light diode integrated circuit 34. For the descriptive convenience, FIG. 5A shows light paths of the light incident to the light diode integrated circuit 34. Solid lines are light paths when there is no shake of the digital photographing apparatus. Broken lines are light paths when the digital photographing apparatus shakes in the direction −x. When the digital photographing apparatus shakes in the direction −x, the light is incident from the center of the light diode integrated circuit 34 to the direction −x. Thus, if the light degree detected in the second region 342 is higher than that detected in the fourth region 344 in FIG. 4C, it is determined that the digital photographing apparatus shakes in the direction −x. An amount of shake of the digital photographing apparatus is determined according to a difference in the light degree detected in the second region 342 and the fourth region 344. The greater the difference, the greater the amount of shake of the digital photographing apparatus.

Referring to FIG. 5B which shows that the digital photographing apparatus shakes in the direction +x, light is incident to the imaging device 30 through the lenses 11 through 15, and a part of the light passing through the lenses 11 through 15 is incident to the light diode integrated circuit 34. For the descriptive convenience, FIG. 5B shows light paths of the light incident to the light diode integrated circuit 34. Solid lines are light paths when there is no shake of the digital photographing apparatus. Broken lines are light paths when the digital photographing apparatus shakes in the direction +x. When the digital photographing apparatus shakes in the direction +x, the light is incident from the center of the light diode integrated circuit 34 to the direction +x. Thus, if the light degree detected in the fourth region 344 is higher than that detected in the second region 342 in FIG. 4C, it is determined that the digital photographing apparatus shakes in the direction +x. An amount of shake of the digital photographing apparatus is determined according to a difference in the light degree detected in the second region 342 and the fourth region 344. The greater the difference, the greater the amount of shake of the digital photographing apparatus.

The direction of shake of the digital photographing apparatus can be determined as shown in FIGS. 5A and 5B since the axis of the light incident to the light diode integrated circuit 34 is not perpendicular to a surface of the light diode integrated circuit 34 to which the light is incident, and the light passing through the lenses 11 through 15 refracts at different angles. An angle and position of the light incident to the light diode integrated circuit 34 may change according to the shake of the digital photographing apparatus; since the position of the light diode integrated circuit 34 shown in FIGS. 5A and 5B changes, the angle between the axis of the light incident to the light diode integrated circuit 34 and the surface of the light diode integrated circuit 34 to which the light is incident changes, or an index or direction of refraction of the light passing through the lenses 11 through 15 changes.

In addition to providing data on the direction and amount of shake of the digital photographing apparatus, the light diode integrated circuit 34 may generate feedback data determining if the position of the imaging device 30 is changed according to the operation of the imaging device base actuator. In particular, if the position of the imaging device 30 is changed according to the operation of the imaging device base actuator, the incident light region of the light diode integrated circuit 34 is the same as shown in FIG. 4A. If the incident light region of the light diode integrated circuit 34 is not the same as shown in FIG. 4A, since the position of the imaging device 30 is erroneously changed, instant feedback is possible.

As described above, the conventional digital photographing apparatus needs two gyro sensors that detect a direction and amount of shake of the digital photographing apparatus and two hall sensors that detect an amount of compensation and provide feedback of the detected amount of compensation in order to prevent image quality from deteriorating due to shaking of the digital photographing apparatus. This conventional design increases the number of necessary parts, renders complex the conventional digital photographing apparatus, and increases manufacturing costs. However, the digital photographing apparatus of the present embodiment can determine the direction and amount of shake of the digital photographing apparatus and generate the feedback data by using the light diode integrated circuit 34. Thus, the structure of the digital photographing apparatus is simple and efficiency thereof is maximized.

Meanwhile, a sub-lens is disposed in a front surface of the light diode integrated circuit 34, if required, so that light can be incident to the light diode integrated circuit 34 through the sub-lens. In general, the lens 10 of the digital photographing apparatus is accurately focused on the imaging device 30. In this case, the light incident to the light diode integrated circuit 34 may not accurately be focused on an incident surface of the light diode integrated circuit 34. Thus, the sub-lens may be disposed in the front surface of the light diode integrated circuit 34 so that the light can be accurately focused on the incident surface of the light diode integrated circuit 34.

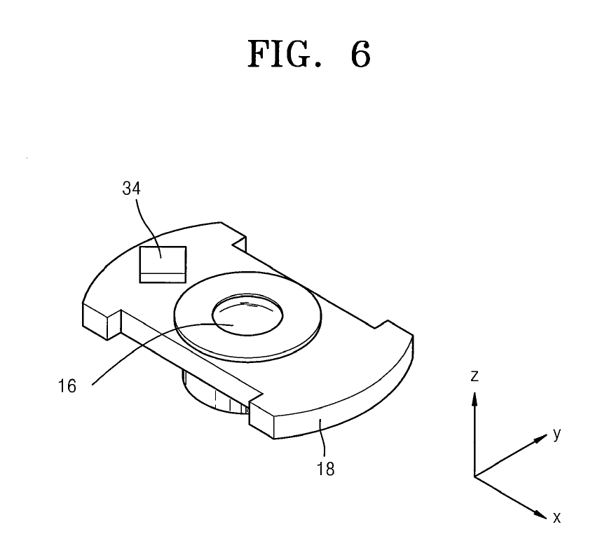

FIG. 6 is a schematic perspective view of a part of a digital photographing apparatus including a shake correction lens 16 according to another embodiment of the present invention.

The digital photographing apparatus of the previous embodiments changes the position of the imaging device 30 in order to prevent reduction in clarity of images from the data generated by the imaging device 30 due to the shake of the digital photographing apparatus, whereas the digital photographing apparatus of the present embodiment changes a position of the shake correction lens 16 included in the lens 10.

In particular, the structure of the digital photographing apparatus of the present embodiment is similar to that of the digital photographing apparatus shown in FIG. 1. The lens 10 includes the shake correction lens 16 disposed in a correction lens base 18 on which the light diode integrated circuit 34 is also disposed. A correction lens base actuator (not shown) moves the correction lens base 18 to control the position of the shake correction lens 16, thereby minimizing a change in the position of light incident to the imaging device 30 although the digital photographing apparatus shakes.

In a similar manner as described with reference to the operation of the digital photographing apparatus of the previous embodiments, the digital photographing apparatus of the present embodiment can detect the direction and amount of shake thereof by analyzing the data generated by the light diode integrated circuit 34. The correction lens base actuator moves the correction lens base 18 based on the detected direction and amount of shake of the digital photographing apparatus, which minimizes the change in the position of the light incident to the image device 30 through the lens 10 including the shake correction lens 16 even though the digital photographing apparatus shakes.

The light incident to the light diode integrated circuit 34 may be a part of the light that passes through the lens 10 or may not pass through the lens 10. The data generated by the light diode integrated circuit 34 may include feedback information determining if the shake correction lens 16 is disposed in a proper position according to the operation of the correction lens base actuator, in addition to information about the direction and amount of shake of the digital photographing apparatus. Therefore, the light incident to the shake correction lens 16 may be a part of the light that passes through the lens 10 and is incident to the light diode integrated circuit 34.

The structure of the light diode integrated circuit 34 and the method of determining the direction and amount of shake of the digital photographing apparatus from the data generated by the light diode integrated circuit 34 are the same as described with reference to FIGS. 3 through 4C.

If it is detected from the data generated by the light diode integrated circuit 34 that the digital photographing apparatus shakes, the correction lens base actuator moves the correction lens base 18 in the opposite direction to the detected direction of shake of the digital photographing apparatus and changes a position of the shake correction lens 16. Thus, although the digital photographing apparatus shakes, an amount of shake in a relative position between the light incident to the imaging device 30 and the imaging device 30 is reduced, so that the imaging device 30 can generate data of a clear image.

The principle of detecting the direction of shake of the digital photographing apparatus in the light diode integrated circuit 34 is the same as described with reference to FIGS. 5A and 5B, except a difference in the position of the light diode integrated circuit 34.

The light diode integrated circuit 34 may generate feedback data determining if the position of the shake correction lens 16 is changed according to the operation of the correction lens base actuator, in addition to the data of the direction and amount of shake of the digital photographing apparatus. In particular, since the light diode integrated circuit 34 moves in the same manner as the direction and amount of shake of the shake correction lens 16, data (a light degree of each of the first region 341 through the fourth region 344) to be generated from the light incident to the light diode integrated circuit 34 can be predicted when the light diode integrated circuit 34 moves by the direction and amount of shake of the shake correction lens 16, the shake correction lens 16 moves by the correction lens base actuator and determines whether the data generated by the light diode integrated circuit 34 is identical to the predicted data, thereby determining whether the position of the shake correction lens 16 is changed by the operation of the correction lens base actuator.

As described above, the conventional digital photographing apparatus needs two gyro sensors that detect a direction and amount of shake of the digital photographing apparatus and two hall sensors that detect an amount of compensation and provide feedback of the detected amount of compensation in order to prevent image quality from deteriorating due to shaking of the digital photographing apparatus, which increases the number of necessary parts, renders complex the conventional digital photographing apparatus, and increases manufacturing costs. However, the digital photographing apparatus of the present embodiment can determine the direction and amount of shake of the digital photographing apparatus and generate the feedback data only by using the light diode integrated circuit 34. Thus, the structure of the digital photographing apparatus is simple and efficiency thereof is maximized.

Meanwhile, a sub-lens is disposed in a front surface of the light diode integrated circuit 34, if required, so that light can be incident to the light diode integrated circuit 34 through the sub-lens. In general, light is adjusted to be accurately focused on the imaging device 30. In this case, the light incident to the light diode integrated circuit 34 disposed on the correction lens base 18 may not accurately be focused on an incident surface of the light diode integrated circuit 34. Thus, the sub-lens may be disposed in the front surface of the light diode integrated circuit 34 so that the light can be accurately focused on the incident surface of the light diode integrated circuit 34.

According to the present invention, although a digital photographing apparatus shakes, the digital photographing apparatus can obtain data of a clear image while the digital photographing apparatus has a simple structure.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

Numerous modifications and adaptations will be readily apparent to those skilled in this art without departing from the spirit and scope of the present invention.

What is claimed is:

1. A digital photographing apparatus comprising:
a lens;
an imaging device that generates data from light incident through the lens;
an imaging device base on which the imaging device is disposed;
a light diode integrated circuit disposed on the imaging device base; and
an imaging device base actuator that moves the imaging device base to control a position of the imaging device.

2. The digital photographing apparatus of claim 1, wherein a part of the light passing through the lens is incident to the light diode integrated circuit.

3. The digital photographing apparatus of claim 2, wherein a surface of the light diode integrated circuit to which light is incident is divided into a first region through a fourth region.

4. The digital photographing apparatus of claim 3, wherein a direction of shake of the digital photographing apparatus is detected according to a difference in an amount of the light detected in the first region through the fourth region of the light diode integrated circuit, and
the imaging device base actuator changes a position of the imaging device in the opposite direction to the detected direction of the shake of the digital photographing apparatus.

5. The digital photographing apparatus of claim 4, wherein if the amount of light detected in the first and third region is greater than that detected in the second and fourth region, the direction of shake of the digital photographing apparatus is determined to be along a y-axis.

6. The digital photographing apparatus of claim 4, wherein if the amount of light detected in the second and fourth regions is greater than that detected in the first and third regions, the direction of shake of the digital photographing apparatus is determined to be along a x-axis.

7. The digital photographing apparatus of claim 6, wherein if the amount of light detected in the second region is greater than that detected in the fourth region, the direction of shake of the digital photographing apparatus is determined to be along a negative x-axis.

8. The digital photographing apparatus of claim 7, wherein further if the amount of light detected in the fourth region is greater than that detected in the second region, the direction of shake of the digital photographing apparatus is determined to be along a positive x-axis.

9. The digital photographing apparatus of claim 2, wherein a sub-lens is disposed in a front of the light diode integrated circuit so that the light is incident to the light diode integrated circuit through the sub-lens.

10. The digital photographing apparatus of claim 1, wherein an axis of the light incident to the light diode integrated circuit is not perpendicular to a surface of the light diode integrated circuit to which the light is incident.

11. A digital photographing apparatus comprising:
a lens including a shake correction lens;
an imaging device that generates data from light incident through the lens;
a correction lens base on which the shake correction lens is disposed;
a light diode integrated circuit disposed on the correction lens base; and
a correction lens base actuator that moves the correction lens base to control a position of the shake correction lens.

12. The digital photographing apparatus of claim 11, wherein a part of the light passing through the lens is incident to the light diode integrated circuit.

13. The digital photographing apparatus of claim 12, wherein a surface of the light diode integrated circuit to which light is incident is divided into a first region through a fourth region.

14. The digital photographing apparatus of claim 13, wherein a direction of shake of the digital photographing apparatus is detected according to a difference in an amount of the light detected in the first region through the fourth region of the light diode integrated circuit, and
the correction lens base actuator changes a position of the shake correction lens in the opposite direction to the detected direction of the shake of the digital photographing apparatus.

15. The digital photographing apparatus of claim 14, wherein if the amount of light detected in the second and fourth regions is greater than that detected in the first and third regions, the direction of shake of the digital photographing apparatus is determined to be along a x-axis.

16. The digital photographing apparatus of claim 15, wherein if the amount of light detected in the second region is greater than that detected in the fourth region, the direction of shake of the digital photographing apparatus is determined to be along a negative x-axis.

17. The digital photographing apparatus of claim 16, wherein further if the amount of light detected in the fourth region is greater than that detected in the second region, the direction of shake of the digital photographing apparatus is determined to be along a positive x-axis.

18. The digital photographing apparatus of claim 12, wherein a sub-lens is disposed in a front of the light diode integrated circuit so that the light is incident to the light diode integrated circuit through the sub-lens.

19. The digital photographing apparatus of claim 11, wherein an axis of the light incident to the light diode integrated circuit is not perpendicular to a surface of the light diode integrated circuit to which the light is incident.

20. A method of reducing the effect of the shaking on a digital photographing apparatus on an image, the method comprising:
generating, by an imaging device, data from light incident through a lens;
providing an imaging device base on which the imaging device is disposed and a light diode integrated circuit is disposed, the light diode integrated circuit including a surface divided into four regions;
detecting a direction of shake of the digital photographing apparatus according to a difference in an amount of light detected in each of the four regions of the surface of the light diode integrated circuit; and
changing a position of the imaging device in the opposite direction to the detected direction of the shake of the digital photographing apparatus by moving the imaging device base.
